(19) United States
(12) Patent Application Publication
(10) Pub. No.: US 2016/0301765 A1
(43) Pub. Date: Oct. 13, 2016

(54) METHOD AND DEVICE FOR PROCESSING SERVICE ACCESS

(71) Applicant: LE HOLDINGS (BEIJING) CO., LTD.

(72) Inventors: Hongfu LI, Beijing (US); Yazhou WU, Beijing (CN)

(73) Assignees: LE HOLDINGS (BEIJING) CO., LTD., Beijing (CN); LE SHI INTERNET INFORMATION TECHNOLOGY CORP. BEIJING, Beijing (CN)

(21) Appl. No.: 15/101,388

(22) PCT Filed: Dec. 22, 2014
(86) PCT No.: PCT/CN2014/094562

§ 371 Date: Jun. 2, 2016

(30) Foreign Application Priority Data
Dec. 27, 2013 (CN) 201310741872.9

(51) Int. Cl. H04L 29/08; H04L 12/891; H04L 12/24; G06F 9/50

(52) U.S. Cl. CPC H04L 67/2833; G06F 9/5005; H04L 47/41; H04L 41/0893

(57) ABSTRACT

Disclosed are a method and device for processing service access, through which service access requests of various service types can be processed in time, and the processing efficiency for the service access requests can be improved. A solution is: a master node in a server acquiring identifiers of service access requests received by the server in a preset time period and the total number of the service access requests; determining service types of the service access requests according to the acquired identifiers of the service access requests and counting the number of service access requests in each service type; and configuring the service process in the server according to the acquired total number of the service access requests, the counted number of the service access requests in each service type and a preset configuration policy. The method and device are applied for processing service access requests.

### CROSS-REFERENCE

This application is based upon Chinese Patent Application 201310741872.9, titled “Method and Device for Processing Service Access”, filed on Dec. 27, 2013, the entire contents of which are incorporated herein by reference.

### TECHNICAL FIELD

The present invention relates to the field of electronic information technologies, and more particularly, to a method and a device for processing service access.

### BACKGROUND

With the development of electronic information technologies, the speed of processing service access requests from a user equipment by a server is required higher and higher in the industry. The server may be configured with multiple service processes, so that the server may process multiple service access requests through various service processes.

In the prior art, although the server may be configured with multiple service processes to process multiple service access requests through multiple service processes, the service access requests received from the user equipment are randomly distributed by the server to any one of service processes configured in the server during the course of implementing the foregoing service access processing, while the number of the service access requests of different service types may be different. Therefore, this may result in a problem that the great mount of service access requests of the service types is unable to be processed in time to affect the processing efficiency of the service access requests.

### SUMMARY

The embodiments of the present invention provide a method and a device for processing service access, through which service access requests of various service types may be processed in time, and the processing efficiency for the service access request may be improved.

In order to fulfill the foregoing object, the embodiments of the present invention employ the following technical solutions.

According to a first aspect, there is provided a method for processing service access, applied in a master node in a server, the method comprises:

acquiring identifiers of service access request received by the server in a preset time period and the total number of the service access requests;

determining service types of the service access requests according to the acquired identifiers of the service access requests and counting the number of the service access requests in each service type; and

configuring the service process in the server according to the acquired total number of the service access requests, the counted number of the service access requests in each service type and a preset configuration policy.

According to a second aspect, there is provided a computer-readable record medium recording a program configured to conduct the method above.

According to a third aspect, there is provided a method for processing service access, applied in a dispatcher node in a server, the method comprises:

receiving service access requests;

determining the service types of the service access requests; and

distributing the service access requests to the service group corresponding to the service type, so that the service process processing the service access requests.

According to a fourth aspect, there is provided a computer-readable record medium recording a program configured to conduct the method above.

According to a fifth aspect, there is provided a master node. The master node is contained in the server. The master node includes:

an acquisition module, configured to acquire identifiers of service access request received by the server in a preset time period and the total number of the service access requests;

a first determination module, configured to determine service types of the service access requests according to the identifiers of the service access requests acquired by the acquisition module and counting the number of the service access requests in each service type; and

a configuration module, configured to configure the service process in the server according to the total number of the service access requests acquired by the acquisition module, the number of the service access requests in each service type counted by the determination module and a preset configuration policy.

According to a sixth aspect, there is provided a dispatcher node. The dispatcher node is contained in the server and includes a reception module, configured to receive service access requests;

a determination module, configured to determine the service types of the service access requests received by the reception module; and

a distribution module, configured to distribute the service access requests to the service process corresponding to the service type determined by the determination module, so that the service process processing the service access requests.

According to a seventh aspect, there is provided a server including a master node and a dispatcher node,

the master node, configured to acquire the identifiers of the service access request received by the server in the preset time and the total number of the service access requests; determine service types of the service access requests according to the acquired identifiers of the service access requests and count the number of the service access requests in each service type; and configure the service process in the server according to the acquired total number of the service access requests, the counted number of the service access requests in each service type and the preset configuration policy; and

the dispatcher node, configured to receive the service access request; determine the service types of the service access requests; and distribute the service access requests to the service group corresponding to the service type, so that the service process processing the service access requests.

### BRIEF DESCRIPTION OF THE DRAWINGS

FIG. 1 is a flow chart of a method for processing service access in the first embodiment according to the present invention;

FIG. 2 is a flow chart of a method for processing service access in the second embodiment according to the present invention;

FIG. 3 is a flow chart of a method for processing service access in the third embodiment according to the present invention;

FIG. 4 is a composition diagram of a master node in the forth embodiment according to the present invention;

FIG. 5 is a composition diagram of another master node in the forth embodiment according to the present invention;

FIG. 6 is a composition diagram of a dispatcher node in the fifth embodiment according to the present invention; and

FIG. 7 is a composition diagram of another dispatcher node in the fifth embodiment according to the present invention.

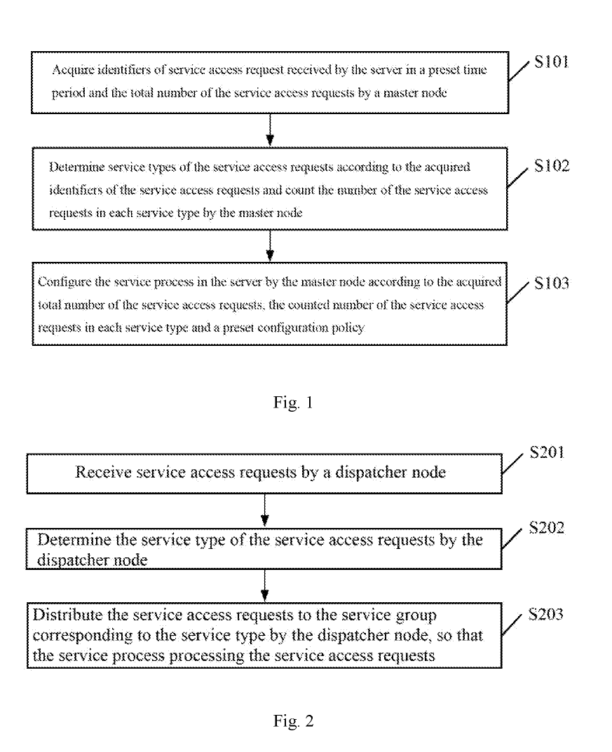

### PREFERRED EMBODIMENTS

The implementation manners of the present application will be explained in details with reference to the drawings and embodiments hereinafter, so that the realization process of how to solve the technical problems using a technical means and achieve the technical efficacy can be sufficiently understood and implemented accordingly.

### Embodiment 1

The embodiment of the present invention provides a method for processing service access capable of being applied in a master node of a server, including the following steps.

In step S101, identifiers of service access request received by the server in a preset time period and the total number of the service access requests are acquired by the master node.

It should be noted that the server in the embodiment of the present invention is an Nginx server. Wherein, Nginx server is not only a high-performance hypertext transfer protocol (Hypertext transfer protocol, HTTP) and reverse proxy server, but also any one of an internet mail access protocol (Internet Mail Access Protocol, IMAP), a post office protocol 3 (Post Office Protocol 3) and a simple mail transfer protocol (Simple Mail Transfer Protocol, SMTP) proxy servers. The Nginx has higher stability, an abundant function set and sample profiles, and lower consumption of system resources.

Wherein, in the embodiment of the present invention, the Ngnix server may be a load balance server. The server process is configured in the server, and corresponding process is called in to process the different service types of service access requests, so as to implement the load balance control of each service process in the server.

In step S102, the service types of the service access requests are acquired by the master according to the acquired identifiers of the service access requests and the number of the service access requests in each service type is counted.

Wherein, the corresponding relation between the identifiers of the different service access requests and the service types of the service access requests may be pre-stored in the server in the embodiment of the present invention. The service types of the service access requests corresponding to the identifier of each service access request may be queried by the master node in the server after acquiring the identifiers of the service access requests and the total number of the service access requests received by the server in the preset time period to determine the service type of each service access request, and then the number of the determined service access requests of all service access requests affiliating to each service type is counted.

In step S103, the service process in the server is configured by the master node according to the acquired total number of the service access requests, the counted number of the service access requests in each service type and a preset configuration policy.

To be specific, the method for configuring the service process in the server by the master node according to the acquired total number of the service access requests, the counted number of the service access requests in each service type and the preset configuration policy may includes: determining the total number of the service processes to be configured in the server by the master node according to the total number of the service access requests; configuring the same number of the service processes as the determined total number of the service processes to be configured in the server; calculating the percentage of the number of the service access requests in the service type accounted in the total number of the service access requests according to the counted number of the service access requests contained in each service type; acquiring the type number of the service types, and determining the grouping number of process groups according to the type number of the service types, the grouping number of the process groups being the same as the type number of the service types, and each process group being corresponding to one service type and being configured to process the service access requests in the service type; and grouping the configured service process for each process group according to the calculated percentage of the number of the service access requests in each service type accounted in the total number of the service access requests, so that the absolute value of the difference between the percentage of the number of the service processes contained in each process group accounted in the determined total number of the service processes to be configured and the percentage of the number of the service access requests in the service type corresponding to the process group accounted in the total number of the service access request being less than a preset threshold.

According to the method for processing the service access provided by the embodiment of the present invention, the identifiers of service access request received by the server in a preset time period and the total number of the service access requests are acquired by the master node in the server; the service types of the service access requests are acquired according to the acquired identifiers of the service access requests, and the number of the service access requests in each service type is counted; the service process in the server is configured according to the acquired total number of the service access requests, the counted number of the service access requests in each service type and the preset configuration policy.

In the prior art, the service access requests received from the user equipment is compared with any one service process configured in the server by the server, and the corresponding number of server processes may be configured by the master node in the server for different service types of service access requests in allusion to the number of different service types of the service access requests. Therefore, various service types of service access requests may be processed in time, and the processing efficiency of the service access requests is improved.

### Embodiment 2

The embodiment of the present invention provides a method for processing service access capable of being applied in a dispatcher node of a server, including the following steps.

In step S201, service access requests are received by the dispatcher node.

Wherein, the service access requests received by the dispatcher node are received by the user equipment from the server.

It should be noted that the server in the embodiment of the present invention is an Nginx server. Wherein, the specific description of the Nginx server may refer to the relevant description in the embodiment. The embodiment of the present invention is not elaborated herein.

In step S202, the service types of the service access requests are determined by the dispatcher node.

Wherein, the corresponding relation between the identifiers of the different service access requests and the service types of the service access requests may be pre-stored in the server in the embodiment of the present invention. The service type of the service access request corresponding to the identifier of each service access request may be queried by the dispatcher node in the server after receiving the service access request, to determine the service type of each service access request.

In step S203, the service access requests are distributed by the dispatcher node to the service group corresponding to the service type, so that the service process processes the service access requests.

Wherein, the method for distributing the service access requests to the service group corresponding to the service type by the dispatcher node so that the service process processing the service access requests may include: distributing the service access requests to the service group corresponding to the service type by the dispatcher, the server being configured with at least two process groups, and each process group comprising at least two service processes; determining the service state of each service process in the process group corresponding to the service type by the dispatcher node; distributing the service access requests to one service process in the process group corresponding to the service type by the dispatcher node according to the service state of each service process in the process group, so that the service process processing the service access requests.

According to the method for processing the service access provided by the embodiment of the present invention, the service access requests are received by the dispatcher node in the server; the service types of the service access requests are determined; the service access requests are distributed to the service process corresponding to the service type, so that the service access requests are processed by the service process.

In the prior art, the service access requests received from the user equipment is compared with any one service process configured in the server by the server, and the different service types of the server access requests may be distributed by the dispatcher node in the server, that is, the service access requests are grouped. Therefore, various service types of service access requests may be processed in time, and the processing efficiency of the service access requests is improved.

### Embodiment 3

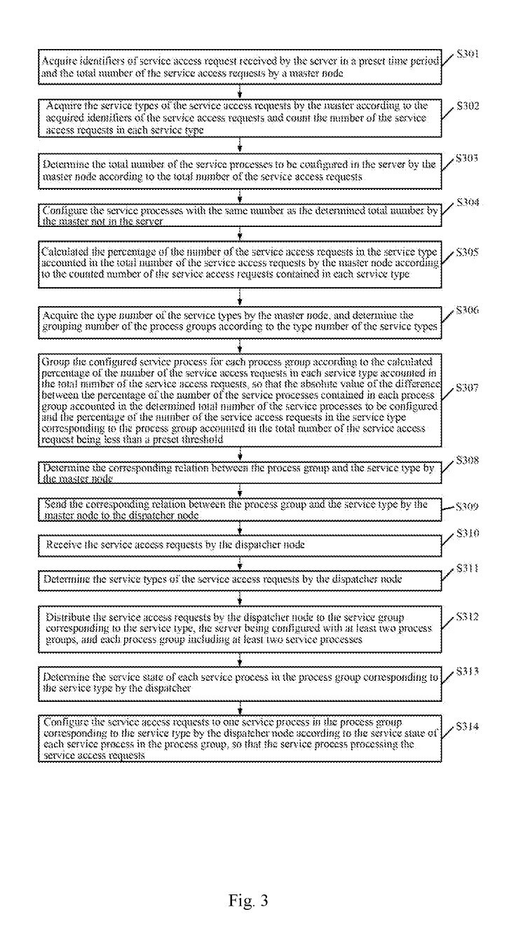

The embodiment of the present invention provides a method for processing service access, as shown in FIG. 3, including the following steps.

In step S301, identifiers of service access request received by the server in a preset time period and the total number of the service access requests are acquired by the master node.

It should be noted that the server in the embodiment is an Nginx server.

To be specific, the master node may read the identifiers of the service access requests received by the server in the preset time period from the server, and count the total number of the server access requests received by the server in the preset time period.

In step S302, the service types of the service access requests are acquired by the master according to the acquired identifiers of the service access requests and the number of the service access requests in each service type is counted.

Wherein, the corresponding relation between the identifiers of the different service access requests and the service types of the service access requests may be pre-stored in the server in the embodiment of the present invention. The service types of the service access requests corresponding to the identifier of each service access request may be queried by the master node in the server after acquiring the identifiers of the service access requests and the total number of the service access requests received by the server in the preset time period to determine the service type of each service access request, and then the number of the determined service access requests of all service access requests affiliating to each service type is counted.

In step S303, the total number of the service processes to be configured in the server is determined by the master node according to the total number of the service access requests.

Wherein, the amount of service processes needed to be configured in the server may be determined according to the acquired total number of service access request. The service access requests may be sufficiently ensured to be processed by the server when receiving multiple service access requests of the total service access requests, that is, the total number of the service processes to be configured in the server is determined.

In step S304, the service processes with the same number as the determined total number are configured by the master not in the server.

In step S305, the percentage of the number of the service access requests in the service type accounted in the total number of the service access requests is calculated by the master node according to the counted number of the service access requests contained in each service type.

To be illustrated, it is assumed that the service types counted by the master node include two service types of live broadcast service type and on-demand service type, and there are three service access requests contained in the live broadcast service type, there are two service access requests contained in the on-demand service type, and there is a total of five service access requests. In this way, the percentage of the number of the service access requests in the live broadcast service type accounted in the total number of the service access requests is (3÷5)×100%=60%. The percentage of the number of the service access requests in the on-demand service type accounted in the total number of the service access requests is (2÷5)×100%=40%.

In step S306, the type number of the service types is acquired by the master node, and the grouping number of the process groups is determined according to the type number of the service types.

Wherein, the grouping number of the process groups is the same as the type number of the service types, wherein, each process groups is corresponding to one service type and is configured to process the service access requests in the service type.

To be illustrated, as was described by the embodiment above, if the service types counted by the master node include two service types of live broadcast service type and on-demand service type, the grouping number of the process groups may be determined by the master node as 2.

In step S307, the configured service process for each process group is grouped according to the calculated percentage of the number of the service access requests in each service type accounted in the total number of the service access requests, so that the absolute value of the difference between the percentage of the number of the service processes contained in each process group accounted in the determined total number of the service processes to be configured and the percentage of the number of the service access requests in the service type corresponding to the process group accounted in the total number of the service access request is less than a preset threshold.

Wherein, the master node may be preset with a preset threshold, for instance, the preset threshold is 15%.

To be illustrated, as was described by the embodiment above, if the master node calculates: the percentage of the number of the service access requests in the live broadcast service type accounted in the total number of the service access requests is (3÷5)×100%=60%; the percentage of the number of the service access requests in the on-demand service type accounted in the total number of the service access requests is (2÷5)×100%=40%. When the total number of the service processes to be configured in the service is determined by the master node as 5, the process group may be divided into 3 service processes by the master node in order to ensure the difference between the percentage (3÷5)×100%=60% of the number of the service processes contained in one process group (i.e., the process group corresponding to the live broadcast service type) accounted in the total number of the determined service processes to be configured and the percentage (3÷5)×100%=60% of the number of the service access requests in the live broadcast service type accounted in the total number of the service access requests is 0. The process group may be divided into 2 service processes by the master node in order to ensure the difference between the percentage (2÷5)×100%=40% of the number of the service processes contained in one process group (i.e., the process group corresponding to the on-demand service type) accounted in the total number of the determined service processes to be configured and the percentage (2÷5)×100%=40% of the number of the service access requests in the on-demand service type accounted in the total number of the service access requests is 0.

Under the situation above, the absolute value 0 of the difference between the percentage (3÷5)×100%=60% of the number of the service processes contained in one process group corresponding to the live broadcast service type accounted in the total number of the determined service processes to be configured and the percentage (3÷5)×100%=60% of the number of the service access requests in the live broadcast service type accounted in the total number of the service access requests is less than the preset threshold 15%; and the absolute value 0 of the difference between the percentage (2÷5)×100%=40% of the number of the service processes contained in one process group corresponding to the on-demand service type) accounted in the total number of the determined service processes to be configured and the percentage (2÷5)×100%=40% of the number of the service access requests in the on-demand service type accounted in the total number of the service access requests is less than the preset threshold 15%.

Further, the percentage of the number of the service processes contained in each process group accounted in the total number of the determined service processes to be configured is not completely equal to the percentage of the number of the service access requests in the service type corresponding to the process group accounted in the total number of the service access requests. The absolute value of the difference between the percentage of the number of the service processes contained in the process group accounted in the determined total number of the service processes to be configured and the percentage of the number of the service access requests in the service type corresponding to the process group accounted in the total number of the service access requests may be less than the preset threshold.

To be illustrated, if the master node calculates: the percentage of the number of the service access requests in the live broadcast service type accounted in the total number of the service access requests as (3÷5)×100%=60%; the percentage of the number of the service access requests in the on-demand service type accounted in the total number of the service access requests as (2÷5)×100%=40%; when there is a total of six service processes to be configured in the server determined by the master node, the process group corresponding to the live broadcast service type may be divided into three service processes by the master node, and the process group corresponding to the on-demand service type may be divided into 3 service processes. At this time, the percentage of the number of the service processes contained in the process group corresponding to the live broadcast service type accounted in the determined total number of the service processes to be configured is (3÷6)×100%=50%; and the percentage of the number of the service processes contained in the process group corresponding to the on-demand service type accounted in the determined total number of the service processes to be configured is (2÷6)×100%=33.3%.

Under the situation above, the absolute value |50%-60%|=10% of the difference between the percentage (3÷6)×100%=50% of the number of the service processes contained in one process group corresponding to the live broadcast service type accounted in the total number of the determined service processes to be configured and the percentage (3÷5)×100%=60% of the number of the service access requests in the live broadcast service type accounted in the total number of the service access requests is less than the preset threshold 15%; and the absolute value |33.3%-40%|=6.7% of the difference between the percentage (2÷6)×100%=33.3% of the number of the service processes contained in one process group corresponding to the on-demand service type) accounted in the total number of the determined service processes to be configured and the percentage (2÷5)×100%=40% of the number of the service access requests in the on-demand service type accounted in the total number of the service access requests is less than the preset threshold 15%.

In step S308, the corresponding relation between the process group and the service type are determined by the master node.

In step S309, the corresponding relation between the process group and the service type is sent by the master node to the dispatcher node.

In step S310, the service access requests are received by the dispatcher node.

In step S311, the service types of the service access requests are determined by the dispatcher node.

In step S312, the service access requests are distributed by the dispatcher node to the service group corresponding to the service type, the server is configured with at least two process groups, and each process group includes at least two service processes.

Wherein, the service access requests are distributed by the dispatcher node to the process group corresponding to the service type according to the corresponding relation of the process group received from the master node with the service type.

It should be noted that the corresponding relation between the process group and the service type may be acquired from the master node by the dispatcher node after determining the service types of the service access requests; the corresponding relation of all process groups with the service type may also be acquired from the master node, and then the acquired corresponding relation is stored, so that the corresponding relation is not needed to be acquired from the master node after determining the service type of the service access requests.

In step S313, the service state of each service process in the process group corresponding to the service type is determined by the dispatcher.

To be specific, the service state of each service process in the process group corresponding to the service type may be acquired by the dispatcher node in real time in order to ensure the service access requests may be processed by the service process in the server in time, so that the service access requests receives may be distributed to the service process that the current service is relatively idle.

In step S314, the service access requests to one service process in the process group corresponding to the service type is configured by the dispatcher node according to the service state of each service process in the process group, so that the service process processes the service access requests.

According to the method for processing the service access provided by the embodiment of the present invention, the identifiers of service access request received by the server in a preset time period and the total number of the service access requests are acquired by the master node in the server; the service types of the service access requests are acquired according to the acquired identifiers of the service access requests, and the number of the service access requests in each service type is counted; the service process in the server is configured according to the acquired total number of the service access requests, the counted number of the service access requests in each service type and the preset configuration policy.

In the prior art, the service access requests received from the user equipment is compared with any one service process configured in the server by the server, and the corresponding number of server processes may be configured by the master node in the server for different service types of service access requests in allusion to the number of different service types of the service access requests. Therefore, the various service types of service access requests may be processed in time, and the processing efficiency of the service access requests is improved.

### Embodiment 4

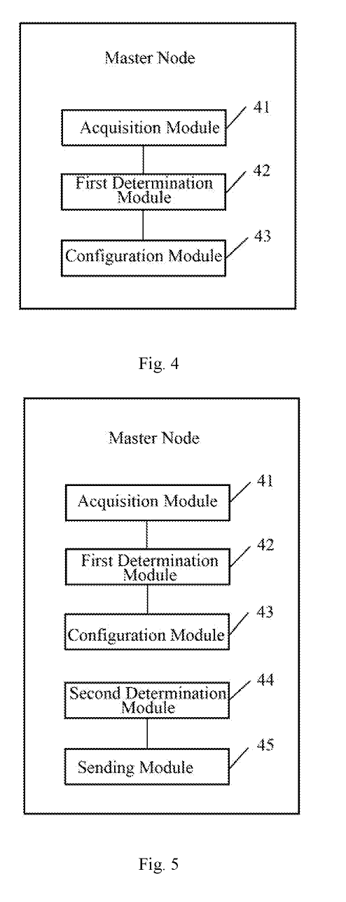

The embodiment of the present invention provides a master node. The master node is contained in a server, as shown in FIG. 4, and the master node includes an acquisition module 41, a first determination module 42 and a configuration module 43.

The acquisition module 41 is configured to acquire identifiers of service access request received by the server in a preset time period and the total number of the service access requests.

The first determination module 42 is configured to determine service types of the service access requests according to the identifiers of the service access requests acquired by the acquisition module and count the number of the service access requests in each service type.

The configuration module 43 is configured to configure the service process in the server according to the total number of the service access requests acquired by the acquisition module, the number of the service access requests in each service type counted by the first determination module 42 and a preset configuration policy.

Further, the configuration module 43 includes a process determination module, a process configuration module, a calculating module, a type acquisition module and a grouping module.

The process determination module is configured to determine the total number of the service processes to be configured in the server according to the total number of the service access requests.

The process configuration module is configured to configure the same number of the service processes as the total number of the service processes to be configured in the server determined by the process determination module.

The calculation module is configured to calculate the percentage of the number of the service access requests in the service type accounted in the total number of the service access requests according to the counted number of the service access requests contained in each service type.

The type acquisition module is configured to acquire the type number of the service types, and determine the grouping number of process groups according to the type number of the service types, the grouping number of the process groups is the same as the type number of the service types, and each process group is corresponding to one service type and is configured to process the service access requests in the service type.

The grouping module is configured to group the configured service process for each process group according to the calculated percentage of the number of the service access requests in each service type accounted in the total number of the service access requests, so that the absolute value of the difference between the percentage of the number of the service processes contained in each process group accounted in the determined total number of the service processes to be configured and the percentage of the number of the service access requests in the service type corresponding to the process group accounted in the total number of the service access request is less than a preset threshold.

Further, FIG. 5 shows the master node, further including a second determination module 44 and a sending module 45.

The second determination module 44 is configured to determine the corresponding relation between the process group and the service type.

The sending module 45 is configured to send the corresponding relation between the process group and the service type determined by the second determination module 44 to a dispatcher node.

Further, the acquisition module 41 is further configured to acquire the identifiers of the service access request received by the server in the preset time and the total number of the service access requests after receiving a process configuration instruction from a user; or configured to acquire the identifiers of the service access request received by the server in the preset time period and the total number of the service access requests in a periodical manner.

It should be noted that the specific description of partial function module in the master node provided by the embodiment of the present invention may refer to the corresponding content in the method embodiment, which will not be elaborated in details herein.

The master node provided by the embodiment of the present invention may acquire the identifiers of the service access request received by the server in the preset time and the total number of the service access requests; determine service types of the service access requests according to the acquired identifiers of the service access requests and count the number of the service access requests in each service type; and configure the service process in the server according to the acquired total number of the service access requests, the counted number of the service access requests in each service type and the preset configuration policy.

In the prior art, the service access requests received from the user equipment is compared with any one service process configured in the server by the server, and the corresponding number of server processes may be configured by the master node in the server for different service types of service access requests in allusion to the number of different service types of the service access requests. Therefore, the various service types of service access requests may be processed in time, and the processing efficiency of the service access requests is improved.

### Embodiment 5

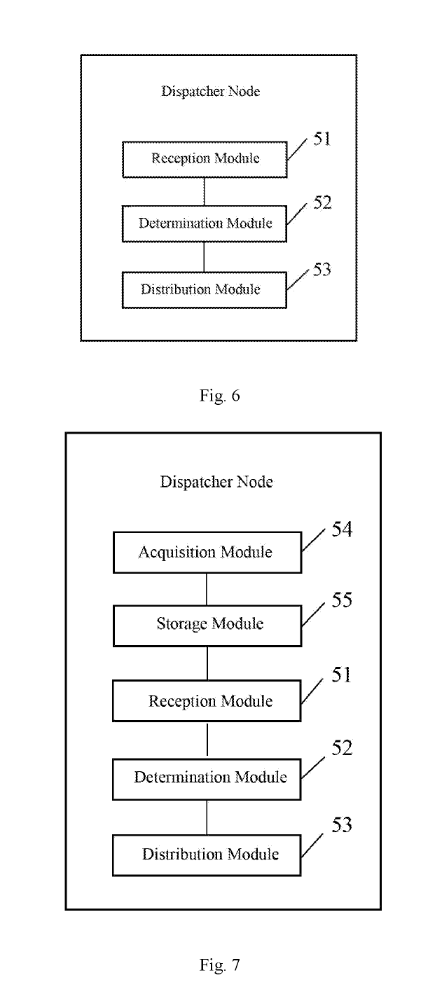

The embodiment of the present invention provides a dispatcher node. The dispatcher node is contained in a server, as shown in FIG. 6, and the dispatcher node includes a reception module 51, a determination module 53 and a configuration module 43.

The reception module 51 is configured to receive service access requests.

The determination module 52 is configured to determine the service types of the service access requests received by the reception module.

The distribution module 53 is configured to distribute the service access requests to the service group corresponding to the service type determined by the determination module, so that the service process processes the service access requests.

Further, the distribution module 53 includes a first distribution module, a state determination module and a second distribution module.

The first distribution module is configured to distribute the service access requests to the service group corresponding to the service type, the server is configured with at least two process groups, and each process group includes at least two service processes.

The state determination module is configured to determine the service state of each service process in the process group corresponding to the service type.

The second distribution module is configured to distribute the service access requests to one service process in the process group corresponding to the service type according to the service state of each service process in the process group, so that the service process processes the service access requests.

Further, FIG. 7 shows the dispatcher node, further including an acquisition module 54 and a storage module 55.

The acquisition module 54 is configured to acquire the corresponding relation between the process group and the service type from a management master node.

The storage module 55 is configured to store the corresponding relation between the process group and the service type acquired by the acquisition module 54.

It should be noted that the specific description of partial function module in the dispatcher node provided by the embodiment of the present invention may refer to the corresponding content in the method embodiment, which will not be elaborated in details herein.

The dispatcher node provided by the embodiment of the present invention may receive the service access request; determine the service types of the service access requests; and distribute the service access requests to the service group corresponding to the service type, so that the service process processes the service access requests.

In the prior art, the service access requests received from the user equipment is compared with any one service process configured in the server by the server, and the different service types of the server access requests may be distributed by the dispatcher node in the server, that is, the service access requests are grouped. Therefore, various service types of service access requests may be processed in time, and the processing efficiency of the service access requests is improved.

### Embodiment 6

The embodiment of the present invention provides a server, including a master node and a dispatcher node.

The master node is configured to acquire the identifiers of the service access request received by the server in the preset time and the total number of the service access requests; determine service types of the service access requests according to the acquired identifiers of the service access requests and count the number of the service access requests in each service type; and configure the service process in the server according to the acquired total number of the service access requests, the counted number of the service access requests in each service type and the preset configuration policy.

The dispatcher node is configured to receive the service access request; determine the service types of the service access requests; and distribute the service access requests to the service group corresponding to the service type, so that the service process processes the service access requests.

It should be noted that the specific description of partial function module in the server provided by the embodiment of the present invention might refer to the corresponding content in the method embodiment, which will not be elaborated in details herein.

The server provided by the embodiment of the present invention may acquire the identifiers of the service access request received by the server in the preset time and the total number of the service access requests; determine service types of the service access requests according to the acquired identifiers of the service access requests and count the number of the service access requests in each service type; and configure the service process in the server according to the acquired total number of the service access requests, the counted number of the service access requests in each service type and the preset configuration policy.

Through the description of the embodiments above, those skilled in the art may clearly understand that, to describe conveniently and simply, it is only illustrated by taking the division of each functional module above as an example for the purpose of convenient and simple description. In practical application, the foregoing function distribution may be finished by different functional modules according to requirements. That is, the interior of the apparatus is divided into different functional modules so as to finish all or part of the functions described above. For specific working processes of the apparatus, device and module described in the foregoing, reference may be made to corresponding processes in the foregoing method embodiments, which will not be elaborated herein.

In several embodiments of the present disclosure, it should be understood that the disclosed system, device, and method might be implemented in other ways. For instance, the device embodiments described above are merely exemplary, for instance, the module or the module grouping is merely logic function grouping, which may be grouped in an additional mode during actual implementation, for instance, multiple modules or components may be combined or may be integrated to another system, or some features may be omitted, or may not be implemented. Another point, the shown or discussed mutual coupling or direct coupling or communication connection may be direct coupling or communication connection through some interfaces, devices or modules, or may be in electric, mechanical or other modes.

The modules described as separate parts may or may not be physically separated from each other, and the parts shown as modules may be one or more physically units, that is, the parts may be located at the same place, and may also be distributed to multiple different places. A part or all of modules may be selected according to the actual requirement to achieve the objectives of the solutions in the embodiments.

In addition, function modules in the embodiments of the present invention may be integrated into a processing module, or each module exists singly and physically, or two or more modules are integrated in one module. The foregoing integrated module may either be fulfilled using a hardware form, or be fulfilled using a software functional module form.

If the integrated module is implemented in the form of a software function module and is sold or used as an independent product, it may be stored in a readable storage medium.

### Embodiment 7

The embodiment of the disclosure further includes a master node apparatus, wherein the master node is contained in a server, comprising:

a processor; and

an memory for storing commands executed by the processor;

wherein the processor is configured to:

acquiring identifiers of service access request received by the server in a preset time period and the total number of the service access requests;

determining service types of the service access requests according to the acquired identifiers of the service access requests and counting the number of the service access requests in each service type; and

configuring the service process in the server according to the acquired total number of the service access requests, the counted number of the service access requests in each service type and a preset configuration policy.

In one embodiment, the processor is further configured to:

determining the total number of the service processes to be configured in the server according to the total number of the service access requests;

configuring the same number of the service processes as the determined total number of the service processes to be configured in the server;

calculating the percentage of the number of the service access requests in the service type accounted in the total number of the service access requests according to the counted number of the service access requests contained in each service type;

acquiring the type number of the service types, and determining the grouping number of process groups according to the type number of the service types, the grouping number of the process groups being the same as the type number of the service types, and each process group being corresponding to one service type and being configured to process the service access requests in the service type; and

grouping the configured service process for each process group according to the calculated percentage of the number of the service access requests in each service type accounted in the total number of the service access requests, so that the absolute value of the difference between the percentage of the number of the service processes contained in each process group accounted in the determined total number of the service processes to be configured and the percentage of the number of the service access requests in the service type corresponding to the process group accounted in the total number of the service access request being less than a preset threshold.

In one embodiment, the processor is further configured to:

determining the corresponding relation between the process group and the service type; and

sending the corresponding relation between the process group and the service type to a dispatcher node.

In one embodiment, the processor is further configured to:

acquiring the identifiers of the service access request received by the server in the preset time and the total number of the service access requests after receiving a process configuration instruction from a user;

or,

acquiring the identifiers of the service access request received by the server in the preset time period and the total number of the service access requests in a periodical manner.

The embodiment of the disclosure further includes another video dispatcher node apparatus, wherein the dispatcher node is contained in a server, and the dispatcher node comprises:

a processor; and

an memory for storing commands executed by the processor;

wherein the processor is configured to:

receiving service access requests;

determining the service types of the service access requests; and

distributing the service access requests to the service group corresponding to the service type, so that the service process processing the service access requests.

In one embodiment, the processor is further configured to:

distributing the service access requests to the service group corresponding to the service type, the server being configured with at least two process groups, and each process group comprising at least two service processes;

determining the service state of each service process in the process group corresponding to the service type; and

distributing the service access requests to one service process in the process group corresponding to the service type according to the service state of each service process in the process group, so that the service process processing the service access requests.

In one embodiment, the processor is further configured to:

acquiring the corresponding relation between the process group and the service type from a management master node; and

storing the corresponding relation between the process group and the service type.

Based on such understanding, the technical solutions of the present invention essentially, or the part contributing to the prior art, or all or a part of the technical solutions may be implemented in the form of a software product. The software product of a computer is stored in a storage medium and includes several instructions for instructing a computer device (which may be a personal computer, a server, or a network device and so on) or a processor (processor) to execute all or a part of steps of the methods described in the embodiments of the present invention. While the abovementioned storage medium includes: any medium that is capable of storing program codes, such as a USB disk, a mobile hard disk drive, a read-only memory (ROM, Read-Only Memory), a random access memory (RAM, Random Access Memory), a magnetic disk, or an optical disk.

The above description is merely detailed implementation manner of the present invention, but not intended to limit the protection scope of the present invention. Any changes or replacements easily figured out by those skilled in the art without departing from the technical scope disclosed by the present invention shall all fall within the protection scope of the present invention. Therefore, the protection scope of the present invention shall be subjected to the protection scope of the claims.

### INDUSTRIAL APPLICABILITY

According to the method and device for processing the service access provided by the present application by applying the foregoing technical solutions, the corresponding number of service processes may be configured by the master node in the server for different service types of service access requests in allusion to different service types of the service access requests. Therefore, various service types of service access requests may be processed in time, and the processing efficiency of the service access requests is improved.

1. A method for processing service access, wherein the method is applied in a master node in a server, comprising:
acquiring identifiers of service access request received by the server in a preset time period and the total number of the service access requests;
determining service types of the service access requests according to the acquired identifiers of the service access requests and counting the number of the service access requests in each service type; and
configuring the service process in the server according to the acquired total number of the service access requests, the counted number of the service access requests in each service type and a preset configuration policy.

2. The method according to claim 1, wherein the step of configuring the service process in the server according to the acquired total number of the service access requests, the counted number of the service access requests in each service type and the preset configuration policy comprises:
determining the total number of the service processes to be configured in the server according to the total number of the service access requests;
configuring the same number of the service processes as the determined total number of the service processes to be configured in the server;
calculating the percentage of the number of the service access requests in the service type accounted in the total number of the service access requests according to the counted number of the service access requests contained in each service type;
acquiring the type number of the service types, and determining the grouping number of process groups according to the type number of the service types, the grouping number of the process groups being the same as the type number of the service types, and each process group being corresponding to one service type and being configured to process the service access requests in the service type; and
grouping the configured service process for each process group according to the calculated percentage of the number of the service access requests in each service type accounted in the total number of the service access requests, so that the absolute value of the difference between the percentage of the number of the service processes contained in each process group accounted in the determined total number of the service processes to be configured and the percentage of the number of the service access requests in the service type corresponding to the process group accounted in the total number of the service access request being less than a preset threshold.

3. The method according to claim 2, further comprising:
determining the corresponding relation between the process group and the service type; and
sending the corresponding relation between the process group and the service type to a dispatcher node.

4. The method according to claim 3, wherein the step of acquiring the identifiers of the service access request received by the server in the preset time and the total number of the service access requests comprises:
acquiring the identifiers of the service access request received by the server in the preset time and the total number of the service access requests after receiving a process configuration instruction from a user;
or,
acquiring the identifiers of the service access request received by the server in the preset time period and the total number of the service access requests in a periodical manner.

5. A computer-readable record medium recording a program configured to conduct the method according to claim 1.

6. A method for processing service access, wherein the method is applied in a dispatcher node in a server, and comprises:
receiving service access requests;
determining the service types of the service access requests; and
distributing the service access requests to the service group corresponding to the service type, so that the service process processing the service access requests.

7. The method according to claim 6, wherein the step of distributing the service access requests to the service group corresponding to the service type, so that the service process processing the service access requests comprises:
distributing the service access requests to the service group corresponding to the service type, the server being configured with at least two process groups, and each process group comprising at least two service processes;
determining the service state of each service process in the process group corresponding to the service type; and
distributing the service access requests to one service process in the process group corresponding to the service type according to the service state of each service process in the process group, so that the service process processing the service access requests.

8. The method according to claim 7, further comprising:
acquiring the corresponding relation between the process group and the service type from a management master node; and
storing the corresponding relation between the process group and the service type.

9. A computer-readable record medium recording a program configured to conduct the method according to claim 6.

10. A master node, wherein the master node is contained in a server, comprising:
an acquisition module, configured to acquire identifiers of service access request received by the server in a preset time period and the total number of the service access requests;
a first determination module, configured to determine service types of the service access requests according to the identifiers of the service access requests acquired by the acquisition module and count the number of the service access requests in each service type; and
a configuration module, configured to configure the service process in the server according to the total number of the service access requests acquired by the acquisition module, the number of the service access requests in each service type counted by the first determination module and a preset configuration policy.

11. The master node according to claim 10, wherein the configuration module comprises:
a process determination module, configured to determine the total number of the service processes to be configured in the server according to the total number of the service access requests;
a process configuration module, configured to configure the same number of the service processes as the total number of the service processes to be configured in the server determined by the process determination module;
a calculation module, configured to calculate the percentage of the number of the service access requests in the service type accounted in the total number of the service access requests according to the counted number of the service access requests contained in each service type;
a type acquisition module, configured to acquire the type number of the service types, and determine the grouping number of process groups according to the type number of the service types, the grouping number of the process groups being the same as the type number of the service types, and each process group being corresponding to one service type and being configured to process the service access requests in the service type; and
a grouping module, configured to group the configured service process for each process group according to the calculated percentage of the number of the service access requests in each service type accounted in the total number of the service access requests, so that the absolute value of the difference between the percentage of the number of the service processes contained in each process group accounted in the determined total number of the service processes to be configured and the percentage of the number of the service access requests in the service type corresponding to the process group accounted in the total number of the service access request being less than a preset threshold.

12. The master node according to claim 11, further comprising:
a second determination module, configured to determine the corresponding relation between the process group and the service type; and
a sending module, configured to send the corresponding relation between the process group and the service type to a dispatcher node.

13. The master node according to the claim 12, wherein the acquisition module is further configured to acquire the identifiers of the service access request received by the server in the preset time and the total number of the service access requests after receiving a process configuration instruction from a user; or configured to acquire the identifiers of the service access request received by the server in the preset time period and the total number of the service access requests in a periodical manner.

14. A dispatcher node, wherein the dispatcher node is contained in a server, and the dispatcher node comprises:
a reception module, configured to receive service access requests;
a determination module, configured to determine the service types of the service access requests received by the reception module; and
a distribution module, configured to distribute the service access requests to the service group corresponding to the service type determined by the determination module, so that the service process processing the service access requests.

15. The dispatcher node according to claim 14, wherein the configuration module comprises:
a first distribution module, configured to distribute the service access requests to the service group corresponding to the service type, the server being configured with at least two process groups, and each process group comprising at least two service processes;
a state determination module, configured to determine the service state of each service process in the process group corresponding to the service type; and
a second distribution module, configured to distribute the service access requests to one service process in the process group corresponding to the service type according to the service state of each service process in the process group, so that the service process processing the service access requests.

16. The dispatcher node according to claim 15, further comprising:
an acquisition module, configured to acquire the corresponding relation between the process group and the service type from a management master node; and
a storage module, configured to store the corresponding relation between the process group and the service type acquired by the acquisition module.

17. A server comprising a master node and a dispatcher node,
the master node, configured to acquire the identifiers of the service access request received by the server in the preset time and the total number of the service access requests; determine service types of the service access requests according to the acquired identifiers of the service access requests and count the number of the service access requests in each service type; and configure the service process in the server according to the acquired total number of the service access requests, the counted number of the service access requests in each service type and the preset configuration policy; and
the dispatcher node, configured to receive the service access request; determine the service types of the service access requests; and distribute the service access requests to the service group corresponding to the service type, so that the service process processing the service access requests.

18. A master node apparatus, wherein the master node is contained in a server, comprising:
a processor; and
an memory for storing commands executed by the processor;
wherein the processor is configured to:
acquiring identifiers of service access request received by the server in a preset time period and the total number of the service access requests;
determining service types of the service access requests according to the acquired identifiers of the service access requests and counting the number of the service access requests in each service type; and
configuring the service process in the server according to the total number of the service access requests, the counted number of the service access requests in each service type and a preset configuration policy.

19. A dispatcher node apparatus, wherein the dispatcher node is contained in a server, and the dispatcher node comprises:
a processor; and
an memory for storing commands executed by the processor;
wherein the processor is configured to:
receiving service access requests;
determining the service types of the service access requests; and
distributing the service access requests to the service group corresponding to the service type, so that the service process processing the service access requests.
